(19) United States
(12) Patent Application Publication
(10) Pub. No.: US 2010/0082782 A1
(43) Pub. Date: Apr. 1, 2010

(54) PROVIDING PERIPHERAL DEVICE ATTRIBUTES TO A CLIENT FOR SELECTION

(76) Inventor: Yi Ding, Saratoga, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/242,585

(22) Filed: Sep. 30, 2008

(51) Int. Cl. G06F 15/177

(52) U.S. Cl. 709/222

(57) ABSTRACT

In an embodiment, a process for automated peripheral device selection implemented by a network host, typically a server. A client accesses the host and requests information about a particular type of peripheral device a user of the client desires to access. In response to the client's request, the host provides the client with a composite list of available attributes associated with the particular type of peripheral device requested by the client. The user selects the desired attributes for the type of peripheral device requested. The process for automated peripheral device selection then selects a peripheral device which most closely matches the user's selected peripheral device attributes.

### TECHNICAL FIELD

The present disclosure relates generally to networked peripheral devices and to selection of networked peripheral devices for use by a client.

### BACKGROUND

Network resources are typically moderated by a server which controls access to available network resources. Client computers, such as laptops, desktops, personal digital assistants, and other clients needing to access available network resources must be properly configured prior to utilizing the available network resources. However, in many cases, the available network resources are unknown until the client computers are actually connected to a network. This situation creates somewhat of a dilemma, since the lack of knowledge about available network resources limits the ability to properly configure the client computers beforehand.

For example, configuration of the client computer may require installation of specific device drivers in order to use the available network resources. The device drivers are typically downloaded from a manufacturer's website and installed on the client computers after users of the clients have ascertained which device drivers are required to use the available network resources. The selection and installation of specific device drivers can be time-consuming and disruptive of existing client computer configurations which may already be properly configured to operate at a different location or on another network subdomain.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### BRIEF DESCRIPTION OF THE DRAWINGS

The features and advantages of the various example embodiments presented in this disclosure will become apparent from the following detailed description when considered in conjunction with the accompanying drawings. Where possible, the same reference numerals and characters are used to denote like features, elements, components or portions of the various inventive embodiments. It is intended that changes and modifications can be made to the described example embodiments without departing from the true scope and spirit of the various inventive concepts as defined by the claims.

In the drawings:

FIG. 1 illustrates an example enterprise network arrangement;

FIG. 2 illustrates an example process for automated peripheral device selection in accordance with an embodiment;

FIG. 3 illustrates a device selection service in accordance with an embodiment;

FIG. 4 illustrates a web-based form in accordance with an embodiment;

FIG. 4A illustrates a web-based form in accordance with an embodiment;

FIG. 4B illustrates a web-based form in accordance with an embodiment;

FIG. 5 illustrates an example computer system architecture.

### DETAILED DESCRIPTION

In the following description, for purposes of explanation, numerous specific details are set forth in order to provide a thorough understanding of the various inventive embodiments. It will be apparent, however, to one skilled in the art that the inventive embodiments may be practiced without these specific details. In other instances, well-known structures and devices are shown in block diagram form in order to avoid unnecessarily obscuring the present inventive embodiments.

Embodiments are described herein according to the following outline:
1.0 General Overview
2.0 Structural and Functional Overview
3.0 Automated Peripheral Device Selection
   3.1 Process for automated peripheral device selection 200
   3.2 Data Structures
   3.3 Web-based forms
4.0 Implementation Mechanisms—Hardware Overview
5.0 Extensions and Alternatives

1.0 General Overview

In an embodiment, a process for automated peripheral device selection is implemented by a network host, typically a server. A client accesses the host and requests information about a particular type of peripheral device that a user of the client desires to access. In response to the client's request, the host provides the client with a composite list of available attributes associated with the particular type of peripheral device requested by the client. The user selects the desired or required attributes for the type of peripheral device requested. In an embodiment, the composite list of available attributes associated with a peripheral device is provided to the client in a web-based format which, when outputted to a display of the client, appears as a form for the user to select the one or more attributes from the composite list of available attributes and optionally selection priorities for the selected attributes for the particular type of peripheral device desired.

The attributes selected by the user for a particular peripheral device typically relate to device capabilities, device locations, device security and optionally, selection priorities for the latter and former. Another attribute typically determined by the host relates to the availability of a potentially selected peripheral device. In an embodiment, the attributes for the available peripheral devices may be obtained from available peripheral devices dynamically when a request for a peripheral device is received by the host. Alternately, the attributes for the available peripheral devices are obtained from the peripheral devices beforehand and are retrievably stored in a database accessible the host.

The selected attributes are then provided to the host for selection of a peripheral device which most closely matches the one or more selected attributes. The selected attributes are used by the host to select a closest match between available peripheral devices and optionally user defined priorities associated with the selected attributes. Once a peripheral device is selected by the host, the physical location of the selected peripheral device is provided to the client. The physical location of the peripheral device allows the user to perform input operations (i.e., convert physical media to logical media) or receive physical outputs (i.e., convert logical media to physical media) from the selected peripheral device. A task to be performed is then routed to the peripheral device for completion.

In an embodiment, the host may act as a proxy for the client, where the host receives the task from the client and performs all of the peripheral device control functions normally specified by local device drivers or an operating system of the requesting computer system. In an alternate embodiment, the client sends the task directly to the selected peripheral device based on logical addressing information for the selected peripheral device or device driver locations provided by the host. Depending on the capabilities of the client or peripheral device, the device driver may be retrieved using a download path obtained for a database and provided to the client to allow the client to work directly with the selected peripheral device.

In an embodiment, an alternate peripheral device may be selected if the task is not successfully performed by the selected peripheral device. The alternate peripheral device normally includes at least a portion of the selected attributes of the previously selected peripheral device. In an embodiment, the automatically selected peripheral device includes a printer, a scanner and a facsimile machine.

In an embodiment, a computer-implemented process for automated peripheral device selection comprises sending to a client computer a composite list of available attributes associated with a type of computer peripheral device; receiving from the client computer one or more attributes selected from the composite list of available attributes for the type of computer peripheral device; selecting a computer peripheral device which includes the selected one or more attributes associated with the type of computer peripheral device; sending to the client computer, a physical location for the selected computer peripheral device; sending to the selected computer peripheral device a task to be completed.

In an embodiment, the process further comprises retrieving a device driver path from a database and sending the device driver path to the client computer. In an embodiment, the process further comprises obtaining the one or more attributes associated with a plurality of computer peripheral devices from a database. In an embodiment, the process further comprises selecting, in response to the selected computer peripheral device failing to complete the task, an alternate computer peripheral device which includes at least a portion of the selected one or more attributes associated with the selected computer peripheral device.

In an embodiment, the process further comprises receiving, from the client computer, a request for the type of computer peripheral device. In an embodiment, the one or more attributes is selected from the group consisting of a device capability, a device location and a selection priority associated with the one or more attributes. In an embodiment, selecting the computer peripheral device comprises determining a closest match of a particular computer peripheral device to the one or more attributes and the selection priority associated with the one or more attributes.

In an embodiment, selecting the computer peripheral device comprises determining a closest match of the one or more attributes, and the selection priority associated with the one or more attributes, to corresponding attributes stored in a database and describing a plurality of potentially available computer peripheral devices. In an embodiment, the composite list of available attributes associated with the requested type of computer peripheral device is provided to the client computer in a format, which when outputted to a display, appears as a form that is configured to enable a user to select the one or more attributes from the composite list of available attributes for the requested type of computer peripheral device.

In an embodiment, the requested type of computer peripheral device is one of a printer, a scanner and a facsimile machine.

In other example embodiments, the disclosure provides a computer apparatus, a computer system and a computer-readable medium configured to carry out the foregoing processes.

2.0 Structural and Functional Overview

In typical enterprise environments, multiple types of peripheral devices may be available and accessed from a network. Even though several peripheral devices may provide the same basic functionality, a particular peripheral device may have additional features not available on other related types of peripheral devices located in the same general vicinity or otherwise available on a particular network subdomain. For example, different kinds of printers may have completely different kinds of features.

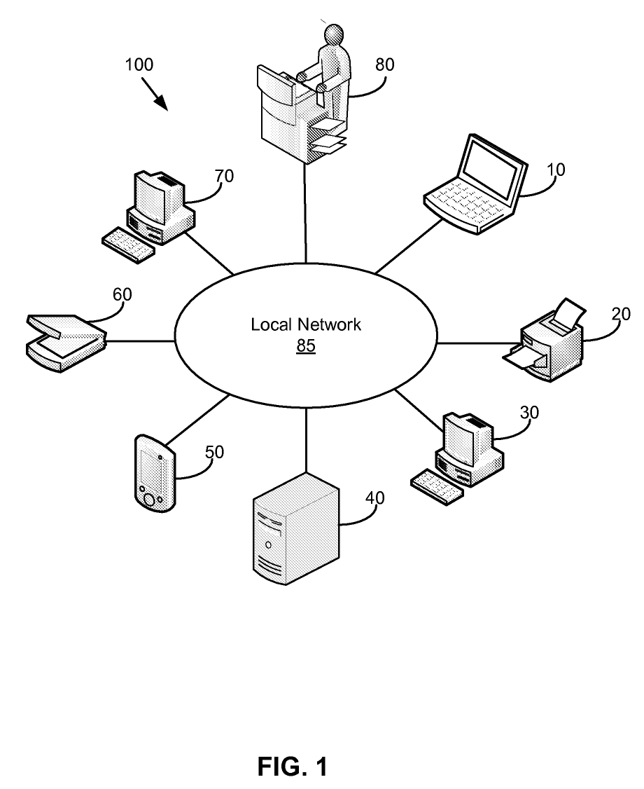

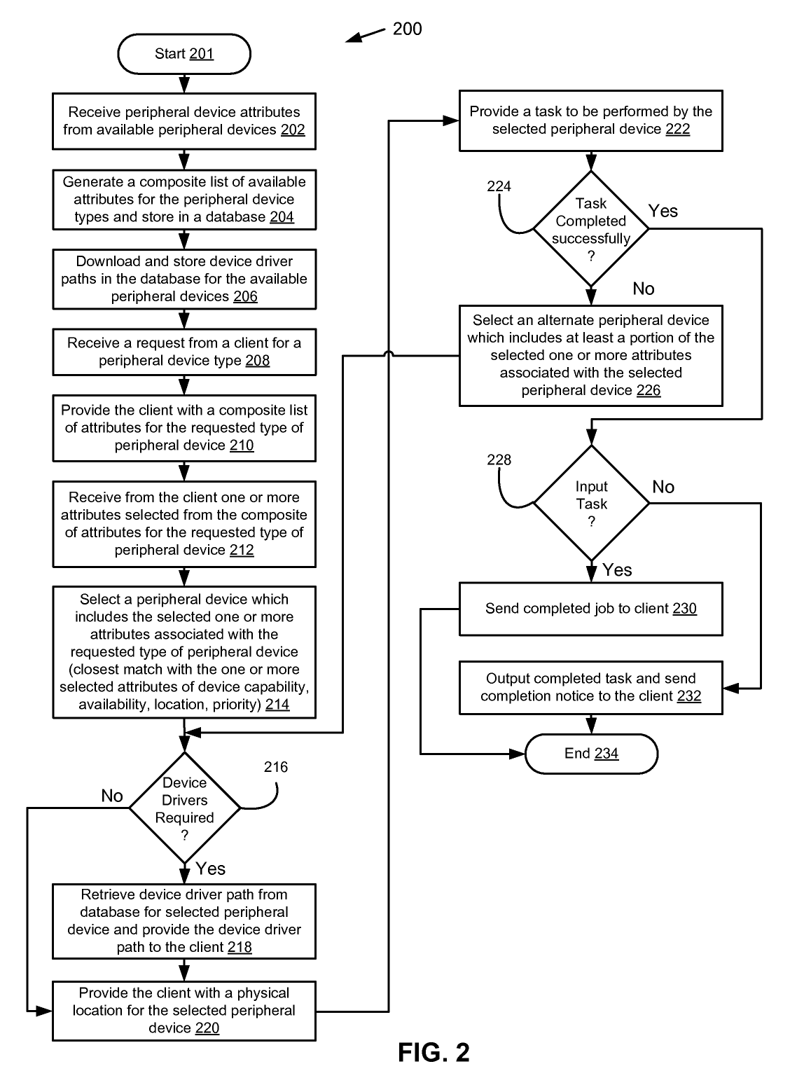

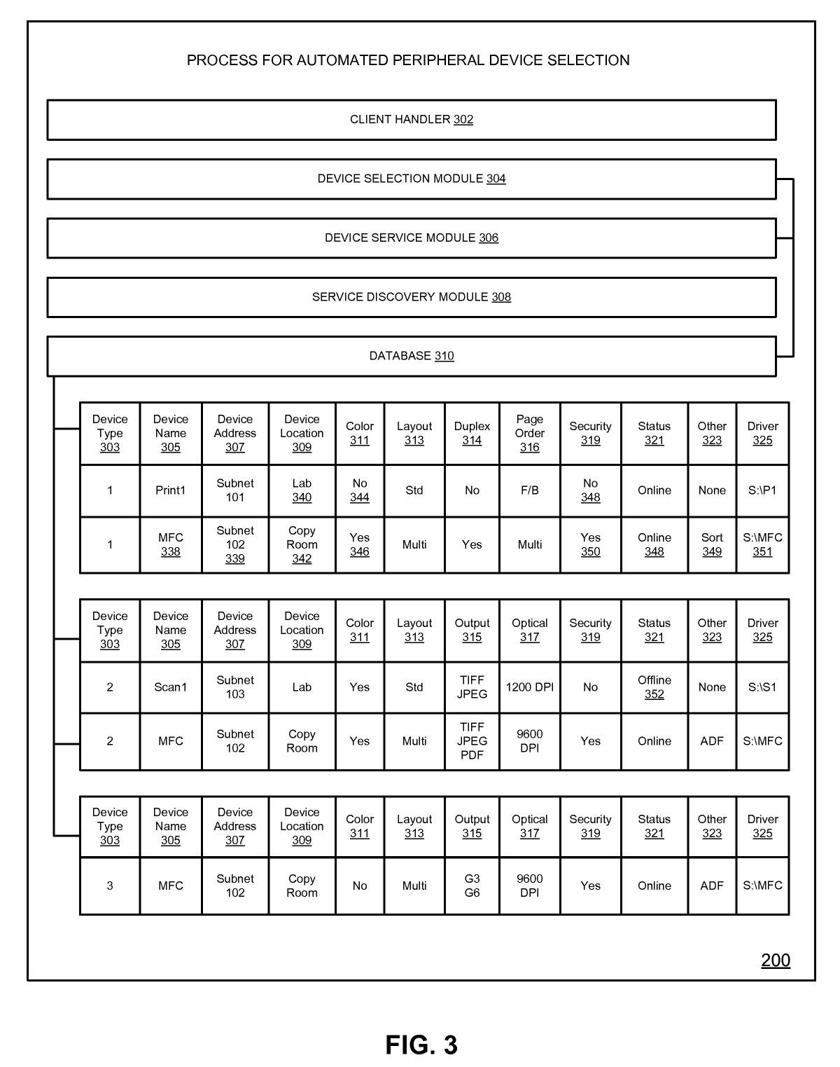

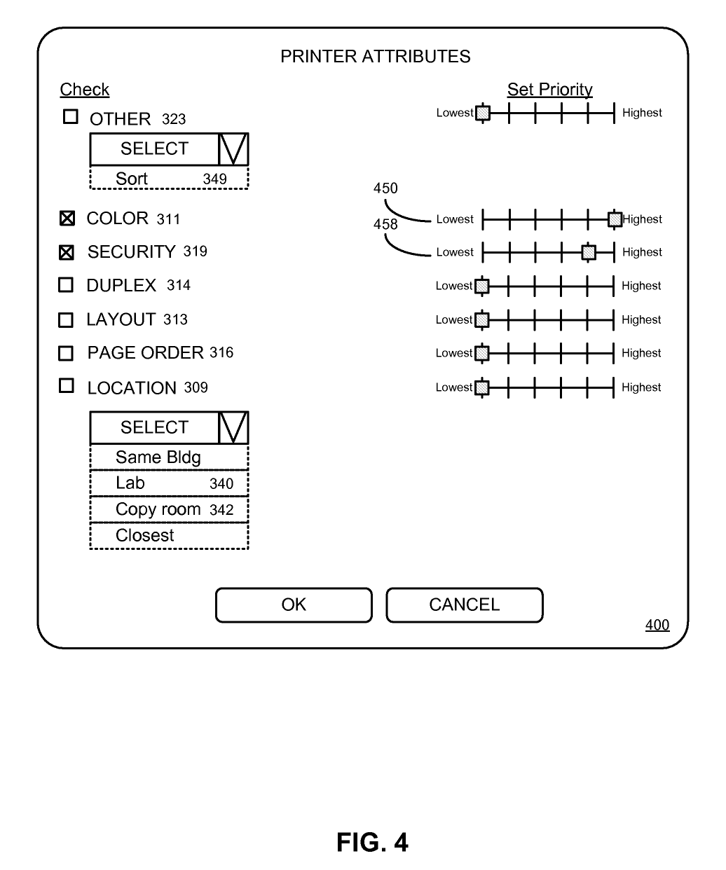

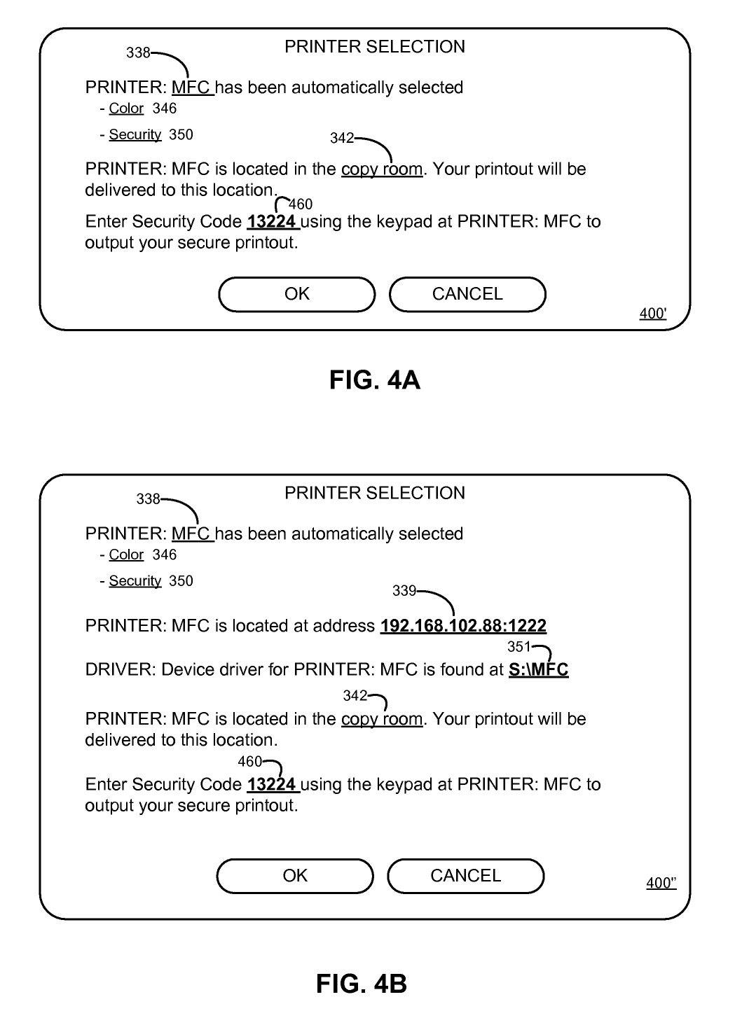

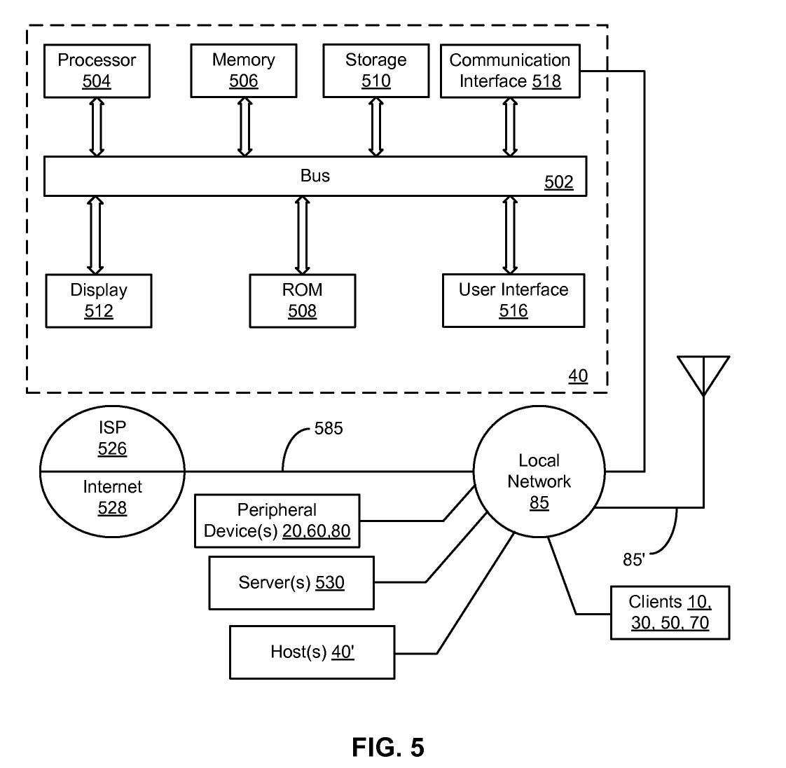

FIG. 1 illustrates an example enterprise network arrangement; FIG. 2 illustrates an example process for automated peripheral device selection; FIG. 3 illustrates a device selection service; FIGS. 4, 4A, 4B illustrate web-based forms in various embodiments; FIG. 5 illustrates an example computer system architecture. Referring first to FIG. 1, an example local network 85 environment comprises a group of client computers 10, 30, 50, 70 (“clients”). In an embodiment, a laptop 10, a pair of computers 30, 70 and a PDA 50 are connected to local network 85 for sharing of network peripheral devices 20, 60, 80, such as a network printer 20, a network scanner 60 and a multifunction document work center 80. A host 40 is connected to local network 85 and is configured to service information requests received from local network 85 for the various peripheral devices 20, 60, 80. Host 40 utilizes peripheral device attributes associated with the various peripheral devices 20, 60, 80 to respond to the peripheral device information requests. The peripheral device attributes include for example, device capabilities, physical locations, logical addresses, device driver storage locations, selection priorities, device security and availability of the various peripheral devices 20, 60, 80.

In an embodiment, host 40 is configured to obtain and retrievably store the attributes in a database 310, as seen in FIG. 3, and associated with the host 40 of FIG. 1. The attributes may be “pulled” as metadata from the various peripheral devices 20, 60, 80 or “pushed” to host 40 as part of a network services announcement. For example, the introduction of a new peripheral device or a change in status of an existing peripheral causes the network services to generate an announcement which is received by host 40. An example of a change in status is going online or offline. An example of announcement type of protocol is described in “Web Services Dynamic Discovery (WS-Discovery),” April 2005, published by the World Wide Web Consortium (W3C) www.w3.org.

To illustrate the operation of host 40 (“host”), an example is now described. However, other embodiments may operate in other ways.

Assume that workers carry portable electronic devices such as laptops, smart phones or PDAs to connect to a network service at alternate workplaces that the portable electronic devices have not been configured to use. In this example, assume that laptop 10 belongs to a mobile worker who is visiting a remote office and needs to print out a confidential report. The user connects his or her laptop 10 to local network 85 and requests information related to available printers on the local network.

In response to the information request, host 40 obtains the attributes for all printers which are available to laptop 10 on local network 85 and generates a composite list of attributes. The composite list of printer attributes is incorporated into a web-based form 400 (FIG. 4) for completion by the user. The web-based form 400 allows the user to select those attributes desired or required for printing the confidential report. In addition, the web-based form 400 optionally allows the user to prioritize his or her attribute selections. The information contained in the completed web-based form 400 is then used by host 40 (FIG. 1) to select a printer that most closely matches the user's desired or required attribute selections and prioritizations. For purposes of this example, the multifunction document work center 80 is selected as the printer which includes all of the selection attributes requested by the user.

Depending on the mode of operation, host 40 may act as a proxy for laptop 10. In a proxy mode of operation, host 40 provides printer device handling and routes tasks from laptop 10 to the selected multifunction document work center 80. In the proxy mode of operation, host 40 also provides a notice 400′—for example, using the form of FIG. 4A—to laptop 10. The notice informs the user where to retrieve his or her printout. The proxy mode of operation provides the ability of a system administrator to limit the general availability of peripheral devices to a subset of all networked peripheral devices for security purposes or other purposes.

In a direct access mode of operation, host 40 provides a different notice 400′, such as the form of FIG. 4B, to laptop 10. The notice includes a logical address, physical location and device driver path for multifunction document work center 80. The direct mode of operation requires less complexity since laptop 10 handles printer control functions and task routing.

3.0 Device Defined User Interface Modifiers

3.1 Process for Automated Peripheral Device Selection

Referring now to FIG. 2, a process for automated peripheral device selection is shown. In an embodiment, process for automated peripheral device selection 200 is initiated as indicated by numeral 201 when at block 202, a host receives or obtains one or more peripheral device attributes for one or more available peripheral devices. For example, host 40 receives or obtains peripheral device attributes for available peripheral devices 20, 60, 80 connected to local network 85. At block 204, a composite list of available attributes for peripheral devices is generated and stored in a database. In an embodiment, a composite list of available attributes for peripheral devices 20, 60, 80, arranged by peripheral device types, is generated and stored in a database 310 associated with host 40.

In an embodiment, at block 206, process 200 stores device driver paths for the available peripheral devices. For example, the process stores device driver paths in database 310 for the available peripheral devices 20, 60, 80.

At block 208, process 200 continues when a request is received from a client for an available peripheral device type. For example, client 10, 30, 50, 70 may issue a request for an available printer, scanner or facsimile device.

At block 210, in response to a request received at block 208, a requesting client is provided with a selectable composite list of available attributes associated with at least one peripheral device type. For example, host 40 provides a requesting client 10, 30, 50, 70 with a selectable composite list of available attributes associated with at least one peripheral device type. In an embodiment, the list of available attributes is dynamically generated from individual attributes stored in database 310. In another embodiment, host 40 polls local network 85 for available peripheral devices 20, 60, 80. A user associated with the requesting client 10, 30, 50, 70 selects the desired list of attributes associated with a requested peripheral device type at block 208.

At block 212, the completed attribute selection and optionally prioritization of attribute selection is used.

At block 214, the process 200 selects a peripheral device which includes the one or more attributes selected by the user for the requested peripheral device type. In an embodiment, the selection is performed based on a closest match with the attributes selected by the user, device capability, availability of a particular peripheral device, location of a particular peripheral device or attribute selection priorities selected by the user.

In an embodiment, at decision block 216, process 200 determines whether device drivers are required in order for the requesting client to utilize the selected peripheral device. At block 218, if device drivers are required, process 200 retrieves the device driver storage path from the database for the selected peripheral device and provides the device driver storage path to the client which allows the client to download and install a required device driver. Alternatively, if no driver is available for the selected peripheral device, then the device can be used in an on-demand manner; for example, on demand printing can be used when no printer driver is available.

At block 220, process 200 provides the client with a physical location for the selected peripheral device. Physical location information may comprise a building identifier, room identifier, pole location identifier, cubicle identifier, or any other information that describes a physical location of a peripheral device in enough detail to enable someone to find the device. In an embodiment, the physical location of the selected peripheral device is sent to the client 10, 30, 50, 70 to allow the user of a requesting client to locate and input physical media into peripheral device 20, 60, 80. Additionally or alternatively, providing the physical location may enable the user to convert the inputted physical media into logical media, for example, by scanning a document into an electronic format. The physical location of the selected peripheral device may be sent when the task to be performed is sent to the selected peripheral device to allow the user to retrieve a physical output (e.g., a printout of data converted from a logical format to a physical format.)

At block 222, in an embodiment, process 200 routes the task to be performed to the selected peripheral device. For example, host 40 may perform the routing. In an alternate embodiment, the task to be performed by selected peripheral device 20, 60, 80 is sent directly from a client 10, 30, 50, 70 to the peripheral device.

In an embodiment, at decision block 224, process 200 determines if the task sent to the selected peripheral device was completed successfully. At block 226, if the task was not completed successfully, process 200 selects an alternate peripheral device that includes at least a portion of the selected attributes associated with the originally selected peripheral device. Process 200 then repeats the actions described herein for blocks 216, 218, 220, 222, 224.

In an embodiment, at decision block 228, process 200 determines whether the task performed by a selected peripheral device was an input task, such as scanning a document. At block 230, in an embodiment, if the task was an input task, process 200 retrieves data resulting from or generated by the completed task from the selected peripheral device and routes the data to the requesting client. In another embodiment, the completed data is sent to directly to a requesting client over the local network.

At block 232, in an embodiment, if the task was not an input task, process 200 sends a task completion notice to a requesting client. In an embodiment, the task completion notice is sent directly to the requesting client 10, 30, 50, 70 over local network 85. In an embodiment, the task completion notice may also include a physical location of the particular peripheral device 20, 60, 80 that completed the task, to enable a user to find the peripheral device and the output of the task.

At block 234, process 200 terminates.

3.2 Data Structures

Referring now to FIG. 3, an example block diagram of the various application modules and database associated with process 200 is shown.

In an embodiment, process 200 may be implemented in one or more computer programs, computer hardware elements, firmware, logic, gates, or other special-purpose computer elements, or any combination thereof, comprising a Client Handler 302, a Device Selection Module 304, a Device Service Module 306, a Service Discovery Protocol Handler 308 and a database 310.

The term “module” as used herein refers to one or more logic elements, gates, circuits, routines, data or data structures that perform a particular task or implement a particular abstract data type. The various modules referred to herein include the necessary interfaces, constants, data types, data structures, variables, and routines that are accessible by other modules or routines, and the routines that implement the functions of the module. The elements of FIG. 3 may comprise a special-purpose computer that is configured to transform an article, such as a peripheral device, to a different state, during operation of the special-purpose computer.

To illustrate a clear example, FIG. 3 is described herein with respect to the example of FIG. 1, but the broad approach of FIG. 3 may be applied in many other contexts.

Service Discovery Protocol Handler 308 is configured for locating available peripheral devices 20, 60, 80 on local network 85. In an embodiment, Service Discovery Protocol Handler 308 is configured to “pull” metadata (i.e., data about the peripheral device data) from each discovered peripheral device found on local network 85. Service Discovery Protocol Handler 308 may utilize any number of service discovery protocols such as Web Services Dynamic Discovery (WS-Discovery), Simple Service Discovery Protocol (SSPS), Service Location Protocol (SLP), or another service discovery protocols known in the relevant art.

The discovery of peripheral devices by Service Discovery Protocol Handler 308 may be accomplished in several ways. For example, when a new peripheral device is initially connected to local network 85, the new peripheral device may send out a broadcast announcement through a network multicast (i.e., “pushed”) to announce itself to local network 85 including host 40. When Service Discovery Protocol Handler 308 receives the announcement, the attributes for the newly discovered peripheral device are sent to Device Service Module 306 for retrievable storage in database 310. Alternately, if one of an existing peripheral device 20, 60, 80 becomes unavailable, the unavailable peripheral device sends out a broadcast announcement through multicast to announce that it is no longer available. In this situation, the attributes for the unavailable peripheral device may be updated or removed from database 310 by Service Discovery Protocol Handler 308.

In an embodiment, Service Discovery Protocol Handler 308 is configured as a subscriber to the network multicast system, or to a publish-subscribe bus such as The Information Bus from TIBCO. If a peripheral device stops working, Service Discovery Protocol Handler 308 receives a notification from the affected peripheral device and sets the device's attribute status 321 in database 310 as “Offline” 356. If Service Discovery Protocol Handler 308 later receives a notification that the peripheral device is available, Service Discovery Protocol Handler 308 resets the peripheral device status to “Online” 348 in database 310.

In another embodiment, when a client 10 requests a specific type of peripheral device, Service Discovery Protocol Handler 308 polls local network 85 for the requested type of peripheral device requested and handles responses received from responding peripheral devices 20, 60, 80. As discussed above, the attributes for the newly discovered peripheral device are sent to the Device Service Module 306 for retrievable storage in database 310.

In an embodiment, Device Service Module 306 also installs the newly discovered peripheral device(s) on host 40 after Service Discovery Protocol Handler 308 discovers the peripheral device(s). As part of the installation process, Service Discovery Protocol Handler 308 installs device drivers when required to utilize the newly discovered peripheral device(s) on host 40. In an embodiment, Device Service Module 306 sends a request to an administrator if a required device driver could not be found. After a device driver is installed in host 40, Device Service Module 306 obtains the attributes for the discovered peripheral devices and stores the retrieved attributes in database 310. In an embodiment, Device Service Module 306 also handles sending data to output peripheral devices, such as printers, and retrieving data from input peripheral devices, such as scanners.

Device Selection Module 304 is configured to perform or support peripheral device selection. In an embodiment, Device Selection Module 304 performs selecting the closest match for the selected attributes, optionally with user defined priorities for attribute selection, for the type of peripheral device requested by the client. Based on the user's requested peripheral device type, Device Selection Module 304 generates a composite attribute list of peripheral device types that are available (or “Online,” as seen at numeral 348), and which most closely match the client's requested peripheral device type using the attributes contained in the database.

Client Handler 302 is configured for tasks involved with communicating with requesting client. In an embodiment, requests are received by Client Handler 302 and routed to Device Selection Module 304 for fulfillment. The initial request received by Client Handler 302 specifies the type of peripheral device sought by requesting client 10, which allows Device Selection Module 304 to query database 310 and generate a composite list of attributes of available peripheral devices which most closely match the particular peripheral device type requested by a client. The composite attribute list is passed to Client Handler 302 which presents the generated composite attribute list in a web-based form, such as form 400 of FIG. 4, which is made available for completion by the user associated with the requesting client.

Attribute data obtained from the completed web-based form 400 is obtained by Client Handler 302 and passed to Device Selection Module 304 for selection of a peripheral device for the requested peripheral device type which most closely matches the user's selected peripheral device capabilities and optionally with user designated priorities assigned to the selected peripheral device capabilities 450, 453 (FIG. 4)

Client Handler 302 also handles output tasks from clients and passes output tasks to Device Service Module 306 which routes output tasks to the selected peripheral device. In this embodiment, Client Handler 302 also receives inputted data from a selected input peripheral device and routes inputted data generated by selected peripheral device 20, 60, 80 to requesting client 10. In embodiments where requesting client 10 accesses the selected peripheral device directly, Client Handler 302 also provides the logical path 325 for downloading of any necessary device drivers needed for using the selected peripheral device. In embodiments where host 40 works as a type of proxy, Client Handler 302 receives tasks from requesting client 10 and routes the tasks to the selected output peripheral device 20, 60, 80.

In an embodiment, database 310 stores peripheral device attributes discovered from the available peripheral devices installed on local network 85. In an embodiment, database 310 includes tables comprising columns for values of Device Type 303, Device Name 305, Device Address 307, Device Location 309, Security 319, and Device Status 321. The value of Device Address 307 is shown as “102” to correspond to the MFC printer described above.

In an embodiment, various attributes specific to particular peripheral devices may be stored. The various peripheral device specific attributes include but are not limited to such peripheral device attributes as Color 311, Layout 313, Duplex 314, Page Order 316, Security 319. In an embodiment, an “Other” field 323 stores more specific capabilities and peripheral device driver storage path 325.

In an embodiment, database 310 may be implemented as part of the Device Selection Module 304. Alternatively, database 310 may be implemented in the form of a lookup table or separate database having fields, data structures, relationships and organization other than as shown in FIG. 3.

3.3 Web-Based Forms

Referring to FIGS. 4, 4A and 4B, examples of web-based forms are shown for implementing the various inventive embodiments. FIG. 4 provides an example web-based form 400 for printer selection in which a user selects the desired attributes and optionally sets priorities for the selected attributes. FIG. 4A provides an example web-based form 400′ for providing a notice to a user of where the physical location of the printer resides and related attributes for the user to receive a printout sent to the selected printer. FIG. 4B provides an example web-based form 400″ for providing a notice to the user of the logical address, the physical location, the logical path for downloading of required device drivers and related attributes for the user to receive a printout sent to the selected printer.

For purposes of illustrating a clear example, FIG. 4, FIG. 4A, and FIG. 4B are described herein in the context of FIG. 1. However, the forms of FIG. 4, FIG. 4A, FIG. 4B may be used in other contexts.

Assume that a user associated with laptop client 10 has requested a printer type of peripheral device from host 40 running process for automated device selection 200. In response, Client Handler 302 passes a “device type” 303 peripheral device request to Device Selection Module 304. Device Selection Module 304 queries database 310 and generates a composite list of attributes for all available printer type peripheral devices which are passed to Client Handler 302 for generation of web-based form 400 of FIG. 4.

Web-based form 400 allows the user of laptop 10 to select those attributes desired or required to accomplish the task of printing his or her document. Assume that the document is a confidential report. In this example, as seen in form 400, the user has selected “Color” 311 and Security 319 as desired or required attributes which map to corresponding fields in database 310. The user has further prioritized the selected attribute of “Color” 311 as the highest priority 450. The user has also prioritized the selected attribute “Security” 319 as well as indicated by numeral 458. In an embodiment, attribute prioritization may be configured so that only a single attribute may have the highest priority other hierarchal arrangements are also envisioned.

The remaining available printer attributes of “Other” 323, “Sort” 349, “Duplex” 314, “Layout” 313, “Page Order” 316, “Location” 309, “Lab” 340 and “Copy Room” 342 are not selected by the user and are not used in peripheral device selection by Device Selection Module 304. The selected printer device attributes of “Color” 311, “Security” 319 and their associated selection priorities 450, 458 are passed by Client Handler 302 to Device Selection Module 304 for selection of a printer peripheral device which most closely matches the selected attributes input into web-based form 400 by the user.

In an embodiment, if no peripheral device includes the desired or required attributes, an error notice is sent to the user advising the user to change his or her requested desired or required attributes. Referring to FIG. 3, in an embodiment, Device Selection Module 304 queries database 310 for an available peripheral device of type printer which, in order of priority, includes color printing capabilities and security. Device Selection Module 304 locates the proper “Device Type” 303. In this example, printers are arbitrarily assigned a device type value of “1”. As discussed in reference to FIG. 1, two printers 20, 80 having device name 314 of “Print1” 336 and “MFC” 338 are installed on local network 85.

Device Selection Module 304 next performs a “Status” 321 verification of the printers “Print1” 336 and “MFC” 338 to ensure both printers are still “Online” as indicated by numerals 352, 354. In this example, since both printers are still online, Device Selection Module 304 then determines which of the two printers 20, 80 provides both the attributes of “Color” 311 and “Security” 319. In this example, only printer “MFC” 338 provides color printing and security as indicated in the associated “Color” attribute field 311 and “Security” attribute field 319 having values “Yes” 346, “Yes” 350. Accordingly, Device Selection Module 304 selects printer “MFC” 338 and passes selection of printer “MFC” 338 to Client Handler 302.

In an embodiment, laptop 10 sends the print task to Client Handler 302 which routes the print task to selected printer “MFC” 338 and notifies the user via client 10 of the selection and location of printer “MFC” 338 as shown in web-based form 400′ (FIG. 4A). In this example, since the user has also specified security as a required attribute, the web-based form 400′ includes a security code 460 which is entered using a keypad associated with printer “MFC” 338 which allows output of the completed color print task (e.g., report) to an output tray associated with “MFC” 338. Alternate security features may be used in addition to or in lieu of security code 460; for example, a smart card or biometric authentication may be used.

In an alternate embodiment, Client Handler 302 sends the network address 339, device driver download path 351 and the “copy room” 342 physical location for printer “MFC” 338 to laptop 10 as is shown in form 400″ of FIG. 4B. In this embodiment, for example, laptop 10 directly accesses and controls printer “MFC” 338 and web-based forms 400, 400′ are not required. In an embodiment, web-based forms 400, 400′, 400″ are rendered in a format which can be rendered using a browser on laptop 10, for example, HTML. In other embodiments, the particular number and types of controls shown in web-based forms 400, 400′, 400″ are not required and other combinations of common graphical user interface controls, such as radial buttons, checkboxes, dropdown lists, slides etc. may be used.

4.0 Implementation Mechanisms—Hardware Overview

FIG. 5 is a block diagram that illustrates a computer system 40 configured as a host to implement the various example embodiments disclosed herein. Host 40 includes a processor 504 for implementing the various executable instructions of process for automated device selection 200. Host 40 (FIG. 5) includes a bus 502 or other communication mechanism for communicating information, and a processor 504 coupled to bus 502 for processing information. Host 40 also includes a main memory 506, such as a random access memory (RAM), flash memory, or other dynamic storage device, coupled to bus 502 for storing information and instructions to be executed by processor 504. Main memory 506 may also be used for storing temporary variables or other intermediate information during execution of instructions to be executed by processor 504. Processor 504 may be of a general purpose complex instruction set computer (CISC) processor commonly associated with desktop computers. In an example embodiment, processor 504 may be a reduced instruction set computer (RISC) processor. In another example embodiment, processor 504 may be application-specific integrated circuit (ASIC) which is programmed to perform a particular function. In an example embodiment, processor 504 may be programmed to execute process for automatic device selection 200 depicted in FIG. 2.

Host 40 (FIG. 5) further includes a read only memory (ROM) 508 or other static storage device coupled to bus 502 for storing static information and instructions for processor 504. A storage device 510, such as a magnetic disk, flash memory or optical disk, may be provided and coupled to bus 502 for storing information and instructions. A communication interface 518 is coupled to bus 502 for communicating information, interrupts and commands to processor 504. Communications interface 518 may be a conventional serial interface such as an RS-232, RS-422, USB, Firewire (TM) or an 802.11 network interface. In an example embodiment, a display 512 is coupled to bus 502 for visually outputting both graphical displays and alphanumeric characters to a user.

A user interface 516 is coupled to bus 502 for sending interrupt signals and user inputs to processor 504 that are used to interpret user interactions with host 40. User interface 516 may be used in conjunction with display 512. For example, a touch screen display. Firmware or software running in host 40 allows external commands to be sent to host 40 via the communications interface 518.

Communications interface 518 may be coupled to one or more external networks 85. The external networks include a local network 85 coupled to one or more hosts 40, 40′, or a global network such as Internet 528 having one or more servers 530 or another networking device via a wireless network 85′. In an embodiment, host 40 is configured as a server which includes all of the functional components of a computers and its associated hardware, operating system (OS) software or operating environment including but not limited to personal computers (PC), desktops, laptops, tablet PC, personal digital assistants (PDA), cellular telephones, Internet appliances, any other intelligent devices, or any desired combination of these devices, that includes components that can execute all, or part, of process for automated device selection 200 as described above.

Host 40 (FIG. 5) may further include standard user interface devices such as a keyboard, a mouse, and a display device, as well as, one or more standard input or output (I/O) devices (not shown), such as a optical disk drive (not shown), floppy disk drive (not shown), or other digital or waveform port (not shown), or other device (not shown) capable of inputting data to or outputting data from host 40. One skilled in the art will appreciate that components not shown associated with host 40 are well known and understood in the relevant art.

Embodiments are related to the use of host 40 with one or more clients 10, 30, 50, 70 and one or more peripheral devices 20, 60, 80 for implementing the techniques described herein. According to an embodiment, those techniques are performed by host 40 in response to processor 504 executing one or more sequences of one or more instructions contained in memory 506. Such instructions may be read into memory 506 from another machine-readable medium, such as storage device 510. Execution of the sequences of instructions contained in memory 506 causes processor 504 to perform the process steps described herein. In alternative embodiments, hard-wired circuitry may be used in place of or in combination with software instructions to implement the process steps. Thus, the various inventive embodiments are not limited to any specific combination of hardware circuitry and software.

The term “machine-readable medium” as used herein refers to any medium that participates in providing data that causes a machine to operate in a specific fashion. In an embodiment implemented using host 40 or clients 10, 30, 50, 70, various machine-readable media are involved, for example, in providing instructions to processor 504 or processors associated with clients 10, 30, 50, 70 for execution. Such a medium may take many forms, including but not limited to storage media and transmission media. Storage media includes both non-volatile media and volatile media. Non-volatile media includes, for example, optical or magnetic disks. Volatile or non-volatile media includes dynamic memory, such as memory 506 or ROM 508. Transmission media includes coaxial cables, copper wire and fiber optics, including the wires that comprise local network 85 and communications link 585. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to host 40 or clients 10, 30, 50, 70 can receive the data on the telephone line and use an infra-red transmitter to convert the data into an infra-red signal. An infra-red detector can receive the data carried in the infra-red signal and appropriate circuitry can carry the data to memory 506, from which processor 504 executes the instructions. The instructions received by memory 506 optionally be stored on storage device 510 either before or after execution by processor 504.

Communication interface 518 provides two-way data communications over local network 85 and communications link 585. Communication interface 518 may be integrated services digital network (ISDN) cards or a modems to provide a data communication connection to a corresponding type of telephone line. As another example, communication interface 518 may be a local area network (LAN) cards to provide a data communication connection to a compatible LAN. Wireless links may also be implemented. In any such implementation, communication interface 518 transceive electrical, radio frequency or optical signals that carry digital data streams representing various types of information.

Communications link 585 between Internet 528 and local network 85 typically provides data communication through one or more networks to other data devices. For example, communications link 585 may provide a connection to a remote host computer (not shown) or to data equipment operated by an Internet Service Provider (ISP) 526. ISP 526 in turn provides data communication services through the world wide packet data communication network now commonly referred to as the “Internet” 528. Communications link 585 and Internet 528 both use electrical, electromagnetic or optical signals that carry digital data streams. The signals through the various networks and the signals on communications link 585, local network 85 and through communication interface 518, which carry the digital data to and from host 40, clients 10, 30, 50, 70 and peripheral devices 20, 60, 80 are example forms of carrier waves transporting the information.

Host 40, clients 10, 30, 50, 70 and peripheral devices 20, 60, 80 can send messages and receive data, including program code, over local network 85, through communications link 585 and communication interface 518. In the Internet example, a server (not shown) might transmit a requested code for an application program through Internet 528, ISP 526, communications link 575, local network 85 and communication interface 518. The received code may be executed by processor 504 as it is received, or stored in a storage device, or other non-volatile storage for later execution. In this manner, host 40, clients 10, 30, 50, 70 or peripheral devices 20, 60, 80 may obtain application code in the form of a carrier wave.

5.0 Extensions and Alternatives

In the foregoing specification, various inventive embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an example rather than a restrictive sense.

What is claimed is:

1. A computer-implemented process for automated peripheral device selection comprising:
sending to a client computer a composite list of available attributes associated with a type of computer peripheral device;
receiving from the client computer one or more attributes selected from the composite list of available attributes for the type of computer peripheral device;
selecting a computer peripheral device which includes the selected one or more attributes associated with the type of computer peripheral device;
sending to the client computer, a physical location for the selected computer peripheral device;
sending to the selected computer peripheral device a task to be completed.

2. The process of claim 1 further comprising retrieving a device driver path from a database and sending the device driver path to the client computer.

3. The process of claim 2 further comprising obtaining the one or more attributes associated with a plurality of computer peripheral devices from a database.

4. The process of claim 1 further comprising selecting, in response to the selected computer peripheral device failing to complete the task, an alternate computer peripheral device which includes at least a portion of the selected one or more attributes associated with the selected computer peripheral device.

5. The process of claim 1 further comprising receiving, from the client computer, a request for the type of computer peripheral device.

6. The process of claim 1 wherein the one or more attributes is selected from the group consisting of a device capability, a device location and a selection priority associated with the one or more attributes.

7. The process of claim 5 wherein selecting the computer peripheral device comprises determining a closest match of a particular computer peripheral device to the one or more attributes and the selection priority associated with the one or more attributes.

8. The process of claim 5 wherein selecting the computer peripheral device comprises determining a closest match of the one or more attributes, and the selection priority associated with the one or more attributes, to corresponding attributes stored in a database and describing a plurality of potentially available computer peripheral devices.

9. The process of claim 1 wherein the composite list of available attributes associated with the requested type of computer peripheral device is provided to the client computer in a format, which when outputted to a display, appears as a form that is configured to enable a user to select the one or more attributes from the composite list of available attributes for the requested type of computer peripheral device.

10. The process of claim 1 wherein the requested type of computer peripheral device is one of a printer, a scanner and a facsimile machine.

11. An apparatus for automated computer peripheral device selection comprising:
a processor;
a network interface configured to communicate data over a data network;
a memory having one or more stored sequences of instructions which, when executed by the processor, cause the processor to:
send to a client computer a composite list of available attributes associated with a type of computer peripheral device;
receive from the client computer one or more attributes selected from the composite list of available attributes for the type of computer peripheral device;
select a computer peripheral device which includes the selected one or more attributes associated with the type of computer peripheral device;
send to the client computer, a physical location for the selected computer peripheral device;
send to the selected computer peripheral device a task to be completed.

12. The apparatus of claim 11 wherein the memory further comprises instructions which when executed cause retrieving a device driver path from a database and sending the device driver path to the client computer.

13. The apparatus of claim 12 wherein the memory further comprises instructions which when executed cause obtaining the one or more attributes associated with a plurality of computer peripheral devices from a database.

14. The apparatus of claim 11 wherein the memory further comprises instructions which when executed cause selecting, in response to the selected computer peripheral device failing to complete the task, an alternate computer peripheral device which includes at least a portion of the selected one or more attributes associated with the selected computer peripheral device.

15. The apparatus of claim 11 wherein the memory further comprises instructions which when executed cause receiving, from the client computer, a request for the type of computer peripheral device.

16. The apparatus of claim 11 wherein the one or more attributes is selected from the group consisting of a device capability, a device location and a selection priority associated with the one or more attributes.

17. The apparatus of claim 15 wherein the memory further comprises instructions which when executed cause selecting the computer peripheral device by determining a closest match of a particular computer peripheral device to the one or more attributes and the selection priority associated with the one or more attributes.

18. The apparatus of claim 15 wherein the memory further comprises instructions which when executed cause selecting the computer peripheral device by determining a closest match of the one or more attributes, and the selection priority associated with the one or more attributes, to corresponding attributes stored in a database and describing a plurality of potentially available computer peripheral devices.

19. The apparatus of claim 11 wherein the composite list of available attributes associated with the requested type of computer peripheral device is provided to the client computer in a format, which when outputted to a display, appears as a form that is configured to enable a user to select the one or more attributes from the composite list of available attributes for the requested type of computer peripheral device.

20. A computer-readable volatile or non-volatile storage medium storing one or more sequences of instructions for automated computer peripheral device selection which instructions, when executed by one or more processors, cause the one or more processors to:
send to a client computer a composite list of available attributes associated with a type of computer peripheral device;
receive from the client computer one or more attributes selected from the composite list of available attributes for the type of computer peripheral device;
select a computer peripheral device which includes the selected one or more attributes associated with the type of computer peripheral device;
send to the client computer, a physical location for the selected computer peripheral device;
send to the selected computer peripheral device a task to be completed.
